(19) United States
(12) Patent Application Publication
(10) Pub. No.: US 2022/0027290 A1
(43) Pub. Date: Jan. 27, 2022

(54) DEVICE AND METHOD FOR CONTROLLING MEMORY ACCESS IN PARALLEL PROCESSING SYSTEM

(71) Applicant: ELECTRONICS AND TELECOMMUNICATIONS RESEARCH INSTITUTE, Daejeon (KR)

(72) Inventors: Kyeong-Eun HAN, Daejeon (KR); Ji Wook YOUN, Daejeon (KR)

(21) Appl. No.: 17/342,816

(22) Filed: Jun. 9, 2021

(30) Foreign Application Priority Data
Jul. 24, 2020 (KR) 10-2020-0092219

(51) Int. Cl. G06F 13/16; G06F 9/48

(52) U.S. Cl. CPC G06F 13/1621; G06F 9/4881; G06F 13/1668; G06F 13/1615

(57) ABSTRACT

A memory access controlling device and method in a parallel processing system are disclosed. The memory access controlling device includes an optical transceiver configured to receive an optical signal including a memory access frame from an optical circuit switch (OCS), a memory access controller configured to perform a scheduling operation and a memory access control operation based on the memory access frame and transmit a memory processing instruction and memory address information to a memory controller, and the memory controller configured to perform at least one of memory data read or memory data write based on the memory processing instruction and the memory address information. The memory access controller includes a plurality of header processors and is configured to control memory processing instructions to be performed in sequential order based on connection information between each of the header processors and a target memory.

### CROSS-REFERENCE TO RELATED APPLICATION(S)

This application claims the priority benefit of Korean Patent Application No. 10-2020-0092219 filed on Jul. 24, 2020, in the Korean Intellectual Property Office, the disclosure of which is incorporated herein by reference for all purposes.

### BACKGROUND

### 1. Field

One or more example embodiments relate to a memory access controlling device and method in a parallel processing system.

### 2. Description of Related Art

Most applications of data centers may intensively use resources of a memory or central processing unit (CPU). Due to such an unbalanced utilization of resources, a data center utilization rate based on an existing server (to a single of which a CPU and a memory are fixed) may be 30 to 40%. A disaggregated resource-based data center may form a single pool of respective resources and share unbalanced resources, and enable an individual upgrade and replacement of resources having different lifespans and specifications. Thus, this type of data center may increase the utilization rate of resources compared to the existing server and is thus receiving attention as a next-generation data center technology.

A current data center has partially disaggregated resources with the disaggregation of a computing device (e.g., a CPU and a graphics processing unit (GPU)) and a storage device. Recently, research has been actively conducted on the disaggregation of a computing device (e.g., a CPU and a GPU) and a memory. For a disaggregated computing device to remotely access and use a disaggregated memory resource, a computing module in a server-based data center may need to access its local memory and perform read and/or write within 700 to 760 nanoseconds (ns). An optical circuit switch (OCS) may be used to satisfy a delay requirement for an optical disaggregation.

In a case of a previous server, simultaneous access to a certain memory may not occur when a computing module of the server performs an operation using its local memory, and thus a collision may not occur in the memory. However, in a case of a disaggregated resource-based data center, each computing device may not be aware of information transmission times of others, and thus may try to access at a time point at which memory access is needed. When two or more computing devices simultaneously request a memory read and/or write instruction to use a remote memory allocated to themselves, a collision between the computing devices may occur in a disaggregated memory. Thus, there is a desire for a memory access technology that may prevent a data collision and a data loss when two or more requests are simultaneously received by a disaggregated memory module. In addition to the memory access technology, there is a desire for various technologies that may maximize a resource utilization rate and efficiency in remote memory access based on a structural characteristic of a disaggregated resource-based data center.

### SUMMARY

According to an example embodiment, there is provided a memory access controlling device in a parallel processing system. The memory access controlling device may include an optical transceiver configured to receive an optical signal including a memory access frame from an optical circuit switch (OCS), a memory access controller configured to perform a scheduling operation and a memory access control operation based on the memory access frame and transmit a memory processing instruction and memory address information to a memory controller, and the memory controller configured to perform at least one of memory data read or memory data write based on the memory processing instruction and the memory address information. The memory access controller may include a plurality of header processors, and control memory processing instructions to be performed in sequential order based on connection information between each of the header processors and a target memory.

The memory access controller may further include a scheduler configured to perform scheduling based on memory access request information received from the header processors such that the header processors have a memory access right in sequential order starting from a header processor selected based on a scheduling result obtained by the scheduling and transmit the scheduling result to a read/write (R/W) connector and the head processors, and the R/W connector configured to connect the header processors to memory read and write paths based on the scheduling result received from the scheduler.

The scheduler may perform a plurality of sub-scheduling stages in parallel.

In the sub-scheduling stages, the scheduling may be performed first for a memory access request with a highest priority based on priority information of memory access requests.

The scheduler may perform, in parallel, scheduling for a memory read request from the header processors and scheduling for a memory write request from the header processors.

The scheduler may read grant information derived as a result of performing the scheduling from a read first in, first out (FIFO) queue and a write FIFO queue based on a priority, and process the read grant information in sequential order.

The scheduler may transmit path information based on the scheduling result to the R/W connector, and transmit a grant signal to a target header processor after setting of a path between the target header processor and the memory controller is completed.

The priority of each of the memory access requests included in the priority information may be defined based on at least two of a memory-intensive application, a central processing unit (CPU)-intensive application, memory read, or memory write.

According to another example embodiment, there is provided a memory access controlling method in a parallel processing system. The memory access controlling method may include receiving an optical signal including a memory access frame from an OCS through an optical transceiver, performing, by a memory access controller, a scheduling operation and a memory access control operation based on the memory access frame and transmitting a memory processing instruction and memory address information to a memory controller, performing, by the memory controller, a memory access operation including at least one of memory data read or memory data write based on the memory processing instruction and the memory address information, and transmitting resultant data obtained by the memory access operation to the OCS through the optical transceiver. The memory access controller may include a plurality of header processors, and control memory processing instructions to be performed in sequential order based on connection information between each of the header processors and a target memory.

The memory access controlling method may further include performing, by a scheduler, scheduling based on memory access request information received from the header processors such that the header processors have a memory access right in sequential order starting from a header processor selected based on a scheduling result obtained by the scheduling, and transmitting the scheduling result to an R/W connector and the head processors.

The memory access controlling method may further include connecting, by the R/W connector, the header processors to memory read and write paths based on the scheduling result received from the scheduler.

In the sub-scheduling stages, the scheduling may be performed first for a memory access request with a highest priority based on priority information.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a parallel processing system according to an example embodiment;

FIG. 2 is a diagram illustrating an example of a memory access controlling device in a parallel processing system according to an example embodiment;

FIG. 3 is a flowchart illustrating an example of a memory access controlling method in a parallel processing system according to an example embodiment;

FIG. 4 is a flowchart illustrating an example of a method performed by a header processor for disaggregated memory read/write access according to an example embodiment;

FIG. 5 is a flowchart illustrating an example of a method performed by a read/write connector for disaggregated memory read/write access according to an example embodiment;

FIG. 6 is a flowchart illustrating an example of a read scheduling method of a parallel processing scheduler according to an example embodiment;

FIG. 7 is a flowchart illustrating an example of a write scheduling method of a parallel processing scheduler according to an example embodiment;

FIG. 8 is a flowchart illustrating an example of an access control function performing method of a scheduler according to an example embodiment;

FIG. 9 is a diagram illustrating an example of a structure and operation of a parallel scheduler based on a priority according to an example embodiment;

FIG. 10 is a flowchart illustrating an example of priority-based read scheduling according to an example embodiment;

FIG. 11 is a flowchart illustrating an example of priority-based write scheduling according to an example embodiment; and

FIG. 12 is a flowchart illustrating an example of an access control function of a scheduler based on a priority according to an example embodiment.

### DETAILED DESCRIPTION

Hereinafter, example embodiments will be described in detail with reference to the accompanying drawings. However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, terms such as first, second, A, B, (a), (b), and the like may be used herein to describe components. Each of these terminologies is not used to define an essence, order, or sequence of a corresponding component but used merely to distinguish the corresponding component from other component(s). Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

In the description of example embodiments, detailed description of structures or functions that are thereby known after an understanding of the disclosure of the present application will be omitted when it is deemed that such description will cause ambiguous interpretation of the example embodiments. Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

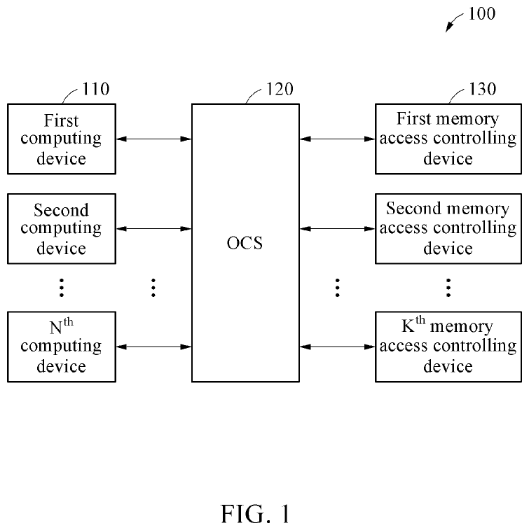

FIG. 1 is a diagram illustrating an example of a parallel processing system according to an example embodiment.

The present disclosure relates to a disaggregated memory access control technology, and more particularly, to a memory access control structure and a scheduler that may enable a plurality of computing resources to use a disaggregated memory without a collision and increase a resource utilization rate. According to an example embodiment, there is provided a device that may enable a plurality of computing resources separated by a distance to access a memory resource without a collision therebetween and effectively use limited resources, and may thus enable the effective use of resources of a data center and an increase in network performance and utilization rate.

According to an example embodiment, there is provided a structure for disaggregated memory access control and a parallel scheduler. According to the example embodiment, computing resources that are separated by a distance may share a certain memory pool without a collision therebetween, and it is thus possible to effectively operate limited resources and increase a resource utilization rate.

According to an example embodiment, there is provided a disaggregated memory access controlling method. The disaggregated memory access controlling method will be described herein based on a memory access controlling structure and method based on a parallel processing scheduler, and a structure, functions, and steps of the parallel processing scheduler.

In the example of FIG. 1, illustrated is a structure in which computing devices 110 and memory access controlling devices 130 are connected through an optical circuit switch (OCS) 120 in a disaggregated data center. In a previous server-oriented data center, computing resources and memory resources are locally connected in a single board. However, in a disaggregated data center network, the computing resources and the memory resources may be formed in different boards and remotely connected.

Referring to FIG. 1, N computing devices 110 may be connected to K memory access controlling devices 130 through an optical switch (e.g., the OCS 120). For example, a memory access controlling device 130 may be a memory pool including a memory read/write (R/W) controller and a plurality of memories connected thereto. In such a connection, the number of the computing devices 110 and the number of the memory access controlling devices 130 may be equal to or different from each other. The optical switch that connects the computing devices 110 and the memory access controlling devices 130 may be an ultrahigh-speed OCS, for example, the OCS 120, to provide low latency. One computing device 110 may be connected to each memory access controlling device 130 through a fixed port. That is, the number of ports of each computing device 110 may be equal to the number of the memory access controlling devices 130 connected to the OCS 120, and the OCS 120 may use (N*K)*(N*K) switches. One computing device 110 may access one or more memory access controlling devices 130 to use a memory resource. In addition, a plurality of computing devices 110 may access a resource of one memory access controlling device 130 based on respectively allocated memory ranges.

The computing devices 110 may transmit read and/or write requests through corresponding ports to use remote memories respectively allocated to the computing devices 110. In such a case, for writing, data may be transmitted along with request information. For example, a memory access controlling device 130 that receives data along with request information from a computing device 110 may process a received instruction and perform read and write instructions. To perform memory read and/or write, an instruction and memory address information may be transferred to a memory controller. For reading, the memory access controlling device 130 may transmit data read from a memory to the computing device 110. For writing, the memory access controlling device 130 may write the received data into the memory and then transmit an acknowledge (or simply “ack”) signal to the computing device 110.

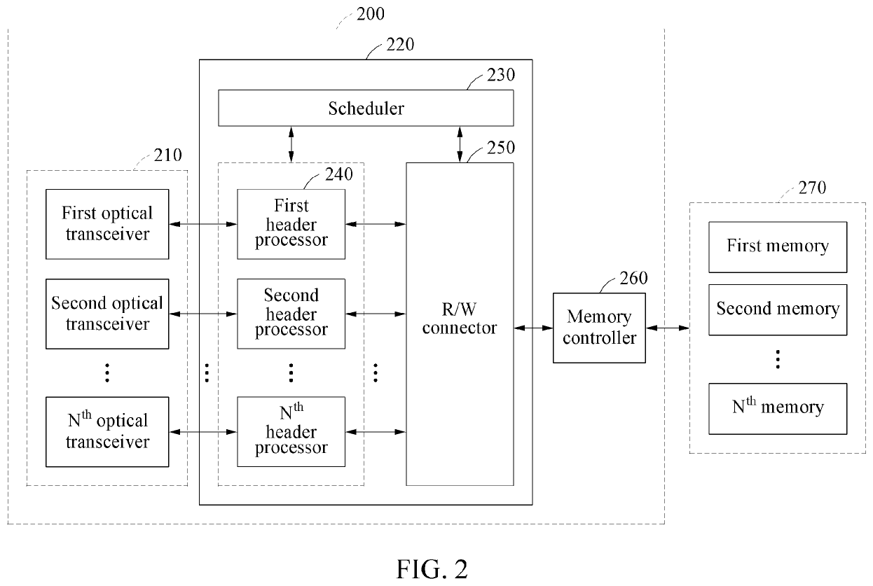

FIG. 2 is a diagram illustrating an example of a memory access controlling device in a parallel processing system according to an example embodiment.

Referring to FIG. 2, a memory access controlling device 200 may include a plurality of optical transceivers 210, a memory access controller 220, and a memory controller 260.

The optical transceivers 210 may receive an optical signal including a memory access frame from an OCS (e.g., the OCS 120 of FIG. 1).

The memory access controller 220 may perform a scheduling operation and a memory access control operation based on the memory access frame. The memory access controller 220 may transmit a memory processing instruction and memory address information to the memory controller 260. The memory access controller 220 may include a plurality of header processors 240, a scheduler 230, and an R/W connector 250.

The memory access controller 220 may control memory processing instructions to be performed in sequential order based on connection information between each of the header processors 240 and each of target memories 270. The memory access controller 220 may further include the scheduler 230. The scheduler 230 may perform scheduling based on memory access request information received from the header processors 240 and allow the header processors 240 to have a memory access right in sequential order starting from a header processor 240 selected based on a result of the scheduling (or simply a “scheduling result”), and transmit the scheduling result to the R/W connector 250 and the header processors 240. The memory access controller 220 may further include the R/W connector 250. The R/W connector 250 may connect the header processors 240 to memory read and/or write paths based on the scheduling result received from the scheduler 230.

The scheduler 230 may transmit path information that is based on the scheduling result to the R/W connector 250. After the setting of a path between a target header processor 240 and the memory controller 260 is completed, the scheduler 230 may transmit a grant signal to the target header processor 240.

The memory controller 260 may perform at least one of memory data reading or memory data writing based on the memory processing instruction and the memory address information.

As described above, the memory access controlling device 200 may include the optical transceivers 210 configured to transmit and receive an optical signal, the memory access controller 220, the memory controller 260 configured to perform actual access to a memory and perform data reading and/or writing, and the memories 270 such as a DDR4 memory. The DDR4 memory, or a 4th-generation double data rate (DDR) memory, is provided merely as an example, and various types of memories may be used. The memory access controller 220 may include the N header processors 240 corresponding to respective inputs and outputs, the scheduler 230, and the R/W connector 250.

Each of the header processors 240 may process a memory access frame received from a computing device 110 and request the scheduler 230 for scheduling. The scheduler 230 may include two parts that perform a scheduling function and an access control function, respectively. The scheduler 230 may perform scheduling based on request information received from each header processor 240 and transmit a scheduling result to the R/W connector 250 and the header processor 240.

The scheduling function of the scheduler 230 may include two sub-scheduling functions (e.g., a memory read scheduling function and a memory write scheduling function) and perform independent scheduling for reading and/or writing based on whether a request is for reading or writing. The access control function of the scheduler 230 may transmit connection information to the R/W connector 250 for path connection, and transmit a grant signal to the header processors 240 to allow memory reading and/or writing to be performed in sequential order without a collision in the memory access controlling device 200. For example, a header processor 240 receiving a grant signal from the scheduler 230 may transmit information and data for memory reading and/or writing to the R/W connector 250. For the memory writing, the header processor 240 may also transmit data to be recorded in a corresponding memory 270. When a write instruction (or an instruction for the writing) is completed, the header processor 240 may generate an acknowledge (or simply “ack”) signal and transmit the ack signal to a corresponding computing device 110. When a read instruction (or an instruction for the reading) is completed, the header processor 240 may generate a response message and transmit the response message along with data read from the memory 270 to the computing device 110.

The R/W connector 250 may connect the header processor 240 to a memory read and/or write path based on the information received from the scheduler 230. Based on the read and/or write related information and data that is transmitted from the header processor 240, actual memory reading and/or writing may be performed through the memory controller 260. The R/W connector 250 may maintain the connection until new information for path resetting is received from the scheduler 230. This is provided merely as an example, and path resetting time and method may vary based on implementation.

According to example embodiments, in a disaggregated data center network, a memory access control structure and a scheduling operation may be used to resolve an issue of a collision that may occur when a plurality of computing modules access certain disaggregated memories. In addition, parallel scheduling may minimize a difference between a memory read and write speed in disaggregated memories and a transmission speed between computing devices and the disaggregated memories, thereby increasing a network resource utilization rate and improving a throughput and a delay performance.

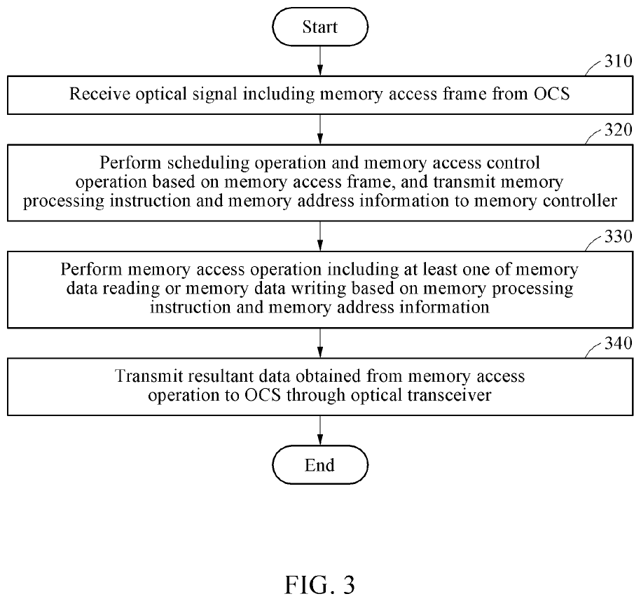

FIG. 3 is a flowchart illustrating an example of a memory access controlling method of a parallel processing system according to an example embodiment.

Referring to FIG. 3, in operation 310, the optical transceivers 210 may receive an optical signal including a memory access frame from the OCS 120.

In operation 320, the memory access controller 220 may perform a scheduling operation and a memory access control operation based on the memory access frame, and transmit a memory processing instruction and memory address information to the memory controller 260.

For example, the memory access controller 220 may perform scheduling by the scheduler 230 based on memory access request information received from the header processors 240, and allow the header processors 240 to have a memory access right in sequential order starting from a header processor 240 selected based on a scheduling result. The memory access controller 220 may transmit the scheduling result to the R/W connector 250 and the header processors 240.

The memory access controller 220 may connect the header processors 240 to memory read and write paths by the R/W connector 250 based on the scheduling result received from the scheduler 230.

In operation 330, the memory controller 260 may perform a memory access operation including at least one of reading data from a memory (or simply “memory data read”) or writing data in the memory (or simply “memory data write”) based on the memory processing instruction and the memory address information.

In operation 340, the memory access controlling device 200 may transmit, to the OCS 120, resultant data obtained from the memory access operation through the optical transceivers 210.

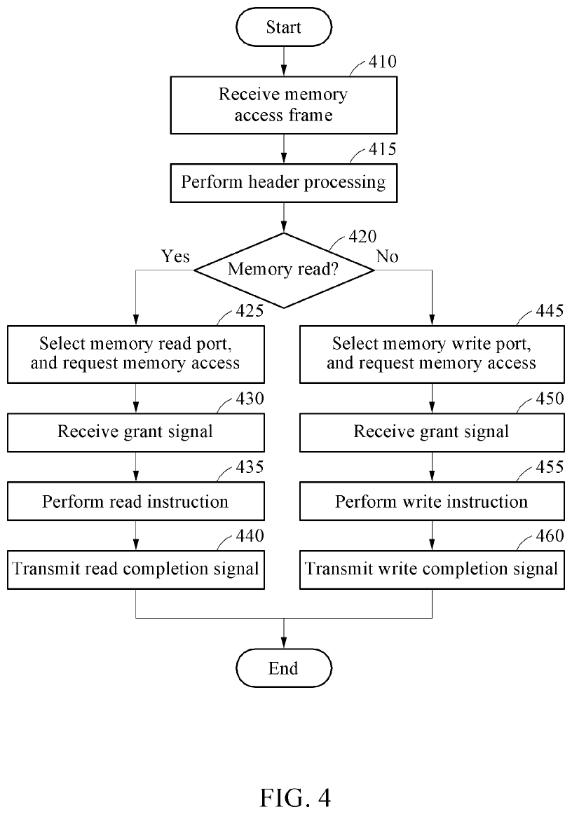

FIG. 4 is a flowchart illustrating an example of a method performed by a header processor 240 for disaggregated memory read and write access according to an example embodiment.

Referring to FIG. 4, in operation 410, a header processor 240 may receive a memory access frame. In operation 415, the header processor 240 may perform header processing. In operation 420, the header processor 240 may verify a memory read and/or write instruction.

In operation 425, in response to the memory read instruction being verified, the header processor 240 may request the scheduler 230 for scheduling through a port connected to memory read scheduling. In operation 430, when the scheduling is completed, the header processor 240 may receive a grant from the scheduler 230. In operation 435, the header processor 240 may perform the memory read instruction. In operation 440, when memory reading is completed, the header processor 240 may transmit a completion signal to the scheduler 230.

In operation 445, in response to the memory write instruction being verified, the header processor 240 may request the scheduler 230 for the scheduling through a port connected to memory write scheduling. In operation 450, when the scheduling is completed, the header processor 240 may receive a grant from the scheduler 230. In operation 455, the header processor 240 may perform the memory write instruction. In operation 460, when memory writing is completed, the header processor 240 may transmit a completion signal to the scheduler 230. The method described above is provided as an example, and various methods may also be used. For example, the methods may include a method of selecting a sub-scheduling stage from among sub-scheduling stages using various sets of information in addition to read and/or write information based on how a parallel scheduler (e.g., the scheduler 230) operates each sub-scheduling stage, and a method of using sub-scheduling selection information for request information although using the same port instead of using a divided port for a connection to the parallel scheduler.

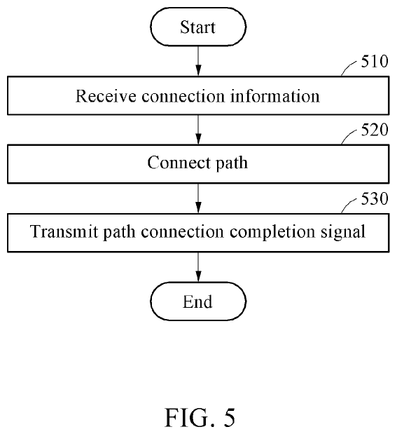

FIG. 5 is a flowchart illustrating an example of a method performed by the R/W connector 250 for disaggregated memory read and write access according to an example embodiment.

Referring to FIG. 5, in operation 510, the R/W connector 250 may receive connection information from the scheduler 230. In operation 520, the R/W connector 250 may connect a corresponding header processor 240 and the memory controller 260 based on the received connection information. In operation 530, when a path connection is completed, the R/W connector 250 may transmit a path connection completion signal to the scheduler 230. The R/W connector 250 may maintain a current set path until a path setting request and connection information are received again from the scheduler 230.

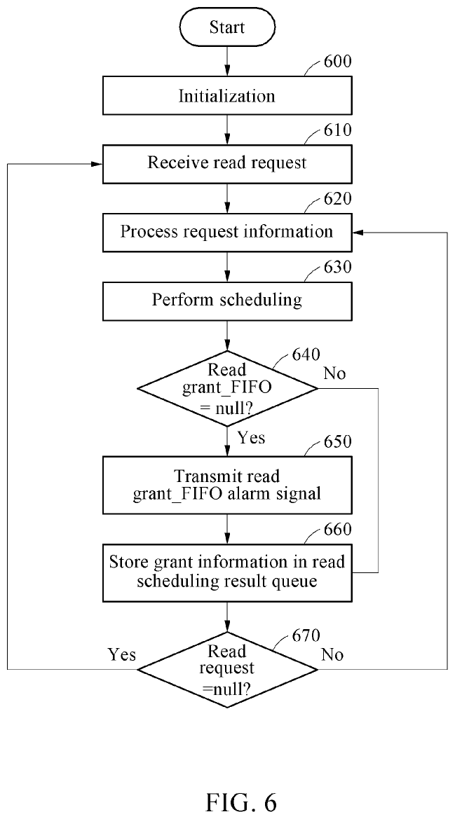

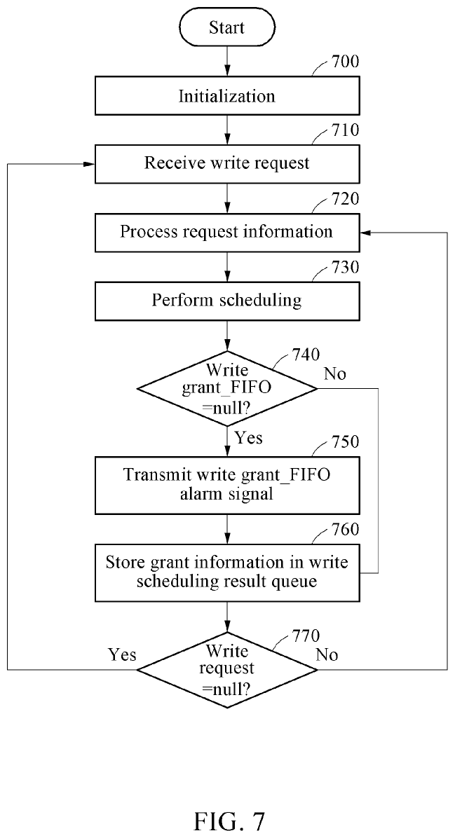

FIGS. 6 and 7 are flowcharts illustrating examples of read and write scheduling methods of the parallel processing scheduler 230 according to an example embodiment.

The scheduler 230 may perform a plurality of sub-scheduling stages in parallel. The scheduler 230 may perform, in parallel, scheduling for a memory read request from the header processors 240 and scheduling for a memory write request from the header processors 240.

A scheduling function (or stage) may include two sub-scheduling functions (or stages as described herein) for independently performing scheduling for reading (or simply “read scheduling) and scheduling for writing (or simply “write scheduling”). Referring to FIGS. 6 and 7, in operations 600 and 700, the scheduler 230 may perform overall initialization. Referring to FIG. 6, in operation 610, a read sub-scheduling stage may receive scheduling request signals from one or more header processors 240.

In operation 620, the read sub-scheduling stage may process request information. In operation 630, the read sub-scheduling stage may perform scheduling between the header processors 240 based on the processed request information, and select one header processor 240 from among the header processors 240 that request reading. The header processors 240 that request the scheduling may have an access right for the memory reading in sequential order, starting from the header processor 240 selected through the scheduling. In operation 640, when the scheduling is completed, the read sub-scheduling stage may verify whether a first in, first out (FIFO) queue, which is a reading grant FIFO queue (or read grant_FIFO as illustrated), is empty or not.

In operation 650, when the grant_FIFO queue is empty, a read grant_FIFO alarm signal may be transmitted to an access control function of the scheduler 230. This is provided merely as an example. Thus, after the scheduling is completed, a scheduling result for path setting may be transmitted to the access control function through various methods. Also, without such a signal transmission, the access control function may continuously monitor the read grant_FIFO queue and use a scheduling result when the scheduling result is stored.

In operation 660, when the alarm signal is transmitted, the read sub-scheduling stage may store grant information in the read grant_FIFO queue. In operation 670, the read sub-scheduling stage may continuously perform the scheduling until a received read request is in a null state. However, when the read grant_FIFO queue is not null, the read sub-scheduling stage may immediately store a scheduling result in the read grant_FIFO queue without transmitting a read grant_FIFO alarm signal, and continuously perform the scheduling until a received read request is in the null state.

Referring to FIG. 7, a write sub-scheduling stage may receive scheduling request signals from one or more header processors 240. In operation 720, the write sub-scheduling stage may process request information. In operation 730, the write sub-scheduling stage may perform scheduling between the header processors 240 based on the processed request information. The write sub-scheduling stage may select one header processor 240 from among the header processors 240 that request writing. The header processors 240 that request the scheduling may have an access right for the memory writing in sequential order, starting from the header processor 240 selected through the scheduling.

In operation 740, when the scheduling is completed, the write sub-scheduling stage may verify whether a writing grant_FIFO queue (or a write grant_FIFO as illustrated) is empty. In operation 750, when the grant_FIFO queue is empty, the write sub-scheduling stage may transmit a write grant_FIFO alarm signal to an access control function of the scheduler 230. This is provided merely as an example. Thus, after the scheduling is completed, a scheduling result for path setting may be transmitted to the access control function through various methods. Also, without such a signal transmission, the access control function may continuously monitor the write grant_FIFO queue.

In operation 760, when the alarm signal is transmitted, the write sub-scheduling stage may store grant information in the write grant_FIFO queue. In operation 770, the write sub-scheduling stage may continuously perform the scheduling until a received write request is in a null state. However, when the write grant_FIFO queue is not null, the write sub-scheduling stage may immediately store a scheduling result in the write grant_FIFO queue without transmitting a write grant_FIFO alarm signal, and continuously perform the scheduling until a received write request is in the null state. This is provided merely as an example, and a sub-scheduling stage may be formed and used based on priority information in addition to read- and/or write-based information.

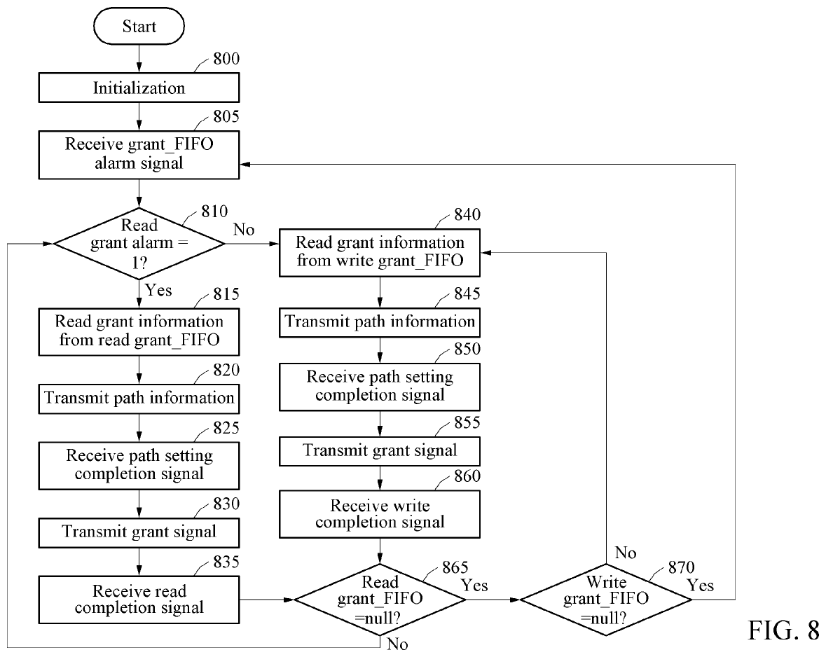

FIG. 8 is a flowchart illustrating an example of an access control function performing method of the scheduler 230 according to an example embodiment.

The scheduler 230 may read grant information that is derived as a result of performing scheduling from a read FIFO queue and a write FIFO queue based on priority information, and process the read grant information in sequential order.

Referring to FIG. 8, in operation 800, the scheduler 230 may perform initialization. In operation 805, the scheduler 230 may receive a read or write grant_FIFO alarm signal.

In operation 810, when the scheduler 230 receives both the read and write grant_FIFO alarm signals, the scheduler 230 may verify first the read grant alarm signal. This is provided merely as an example. For example, the scheduler 230 may select an instruction with a higher priority from between read and write instructions, and process the selected instruction. For example, in operation 815, when the grant_FIFO alarm signal is received, the scheduler 230 may read grant information from a read grant_FIFO queue. In operation 820, the scheduler 230 may transmit information of a selected header processor 240 to the R/W connector 250.

In operation 825, the scheduler 230 receives a path setting completion signal transmitted after the R/W connector 250 completes path setting. In operation 830, the scheduler 230 may transmit a grant signal to the header processor 240. In operation 835, the scheduler 230 may receive a memory read completion signal from the header processor 240. In operation 865, the scheduler 230 may verify whether a read grant_FIFO with a high priority is null in order for next path setting. When the read grant_FIFO is not null, the scheduler 230 may read grant information for the next path setting from the read grant_FIFO queue, and repeat the path setting and the transmission of a grant signal.

In operation 870, when the read grant_FIFO is null, the scheduler 230 may verify whether a write grant_FIFO is null. In operation 840, when the write grant_FIFO is not null, the scheduler 230 may read grant information from a write grant_FIFO queue. In operation 845, the scheduler 230 may transmit information of a corresponding header processor 240 to the R/W connector 250 for path setting. In operation 850, the scheduler 230 may receive a path setting completion signal. In operation 855, the scheduler 230 may transmit a grant signal to the header processor 240.

In operation 860, the scheduler 230 may receive a memory write completion signal from the header processor 240. In operation 865, the scheduler 230 may verify first whether the read grant_FIFO is null in order for next path setting. When both the read and write grant_FIFO queues are null, the scheduler 230 may wait until a grant_FIFO alarm signal is received. For example, when a write grant_FIFO alarm signal is received in operation 805, the scheduler 230 may read grant information from the write grant_FIFO queue in operation 840, and transmit information of a corresponding header processor 240 to the R/W connector 250 in operation 845 in order for path setting. When a path setting completion signal is received in operation 850, the scheduler 230 may transmit a grant signal to the header processor 240 in operation 855.

When a memory write completion signal is received from the header processor 240 in operation 860, the scheduler 230 may verify first whether the read grant_FIFO is null in operation 865 in order for next path setting. In operation 870, when the read grant_FIFO is null, the scheduler 230 may verify whether the write grant_FIFO is null. When the write grant_FIFO is not null, the scheduler 230 may read grant information from the write grant_FIFO queue in operation 840 in order for the next path setting, transmit the information to the R/W connector 250 in operation 845, set a path in operation 850, and then transmit a grant signal to a corresponding header processor 240 in operation 855. When a write completion signal is received from the header processor 240 in operation 860, the scheduler 230 may repeat the operations described above to set a next path.

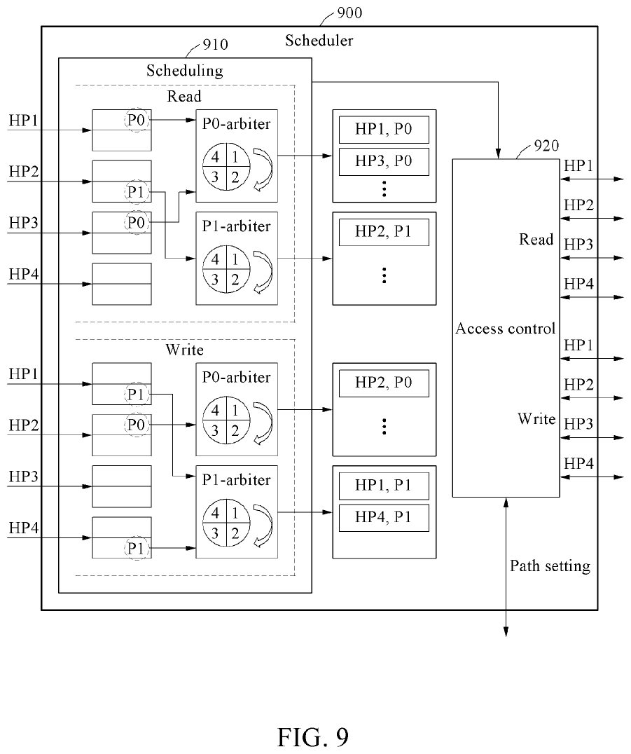

FIG. 9 is a diagram illustrating an example of a structure and operation of a parallel scheduler 900 based on a priority according to an example embodiment.

A plurality of sub-scheduling stages 910 may perform scheduling based on priority information associated with priorities of memory access requests. For example, as illustrated in FIG. 9, the scheduler 900 may have a scheduling function including two sub-scheduling stages 910 for read scheduling and write scheduling, and have an access control function 920. The is provided merely as an example, and the functions may be implemented as a single function according to implementation. The priorities may be defined in various ways. For example, in a case in which K priorities are considered, each sub-scheduling stage may have K arbiters or less than K arbiters according to implementation.

FIG. 9 illustrates the scheduler 900 which is a read- and/or write-based parallel scheduler having two priorities. Each sub-scheduling stage that receives request information from header processors, for example, HP1 through H4 as illustrated, that desire to have a memory read or write access may perform scheduling for requests having the same priority. Each sub-scheduling stage may perform first the scheduling in response to a request with a higher priority such that the request to be allocated first. For example, scheduling for a request with a higher priority, for example, priority 0 (or P0 as illustrated), may be performed first. When the scheduling for all P0 requests is completed, scheduling for a lower priority, for example, priority 1 (or P1 as illustrated), may be performed subsequently. For the same priority, round-Robin (RR) scheduling may be performed. However, this is provided merely as an example, and various scheduling methods may be used according to implementation.

Grant information obtained through the scheduling performed at each sub-scheduling stage may be stored in sequential order in priority-based read grant_FIFO and write grant_FIFO queues. This may be repeated until scheduling for all the header processors (e.g., HP1 through H4) that is requested to each sub-scheduling stage is completed.

The grant information may include information of a selected header processor and corresponding priority information. For example, a higher priority may be given in the order of read-P0, to write-P0, read-P1, and write-P1, as illustrated in FIG. 9. The access control function 920 of the scheduler 900 may read scheduling information stored in a corresponding grant_FIFO queue in sequential order based on a determined priority, and then transmit it to the R/W connector 250 to set a path between a corresponding header processor and the memory controller 260.

When a path setting completion message is received from the R/W connector 250, the scheduler 900 may transmit a grant signal to the corresponding header processor. When a read and/or write completion signal is received from the header processor, the scheduler 900 may read information from a next grant_FIFO queue in order for new path setting. The access control function 920 of the scheduler 900 may repeat an operation of setting a next memory access path in sequential order until all the queues are all in a null state.

TABLE 1

| Priority | | | |
|---|---|---|---|
| A1 | A0 | Description | |
| 0 | 0 | Memory intensive | Read |
| | 1 | | Write |
| 1 | 0 | CPU intensive | Read |
| | 1 | | Write |

Table 1 indicates example priorities defined based on a memory-intensive application, a central processing unit (CPU)-intensive application, memory reading, and memory writing. The memory-intensive application may be sensitive to a delay, and the CPU-intensive application may be less sensitive to a delay. However, this is provided merely as an example, and thus a plurality of priorities for memory reading and/or writing may be defined based on various sets of information including, for example, a delay, a service rating, or the like.

A priority of each memory access request included in the priority information may be defined based on at least two of the memory-intensive application, the CPU-intensive application, the memory reading, or the memory writing.

For example, in a case in which a single scheduler, for example, the scheduler 900, simultaneously performs read scheduling and write scheduling, four priorities may be generated. In this case, the priorities may be determined in the order of P0 (memory-intensive-read), P1 (memory-intensive-write), P2 (CPU-intensive-read), and P3 (CPU-intensive-write). In a case of using two sub-scheduling stages to perform the read scheduling and the write scheduling independently, two priorities may be generated for each reading and writing, and the priorities may be determined in the order of P0 (memory-intensive) and P1 (CPU-intensive). In this case, the access control function 920 of the scheduler 900 may put a higher priority in the order of read-P0, write-P0, read-P1, and write-P1, and thus a header processor 240 with a higher priority may be assigned with a memory access right.

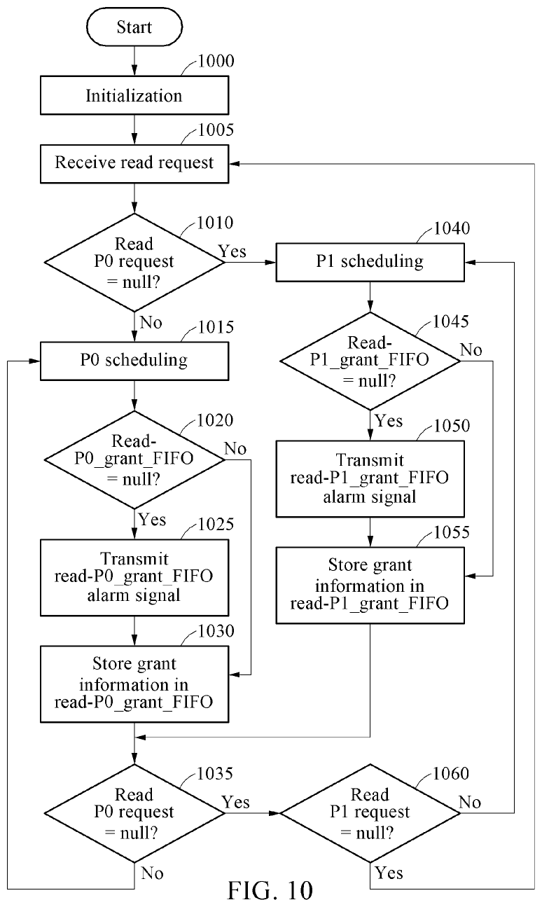

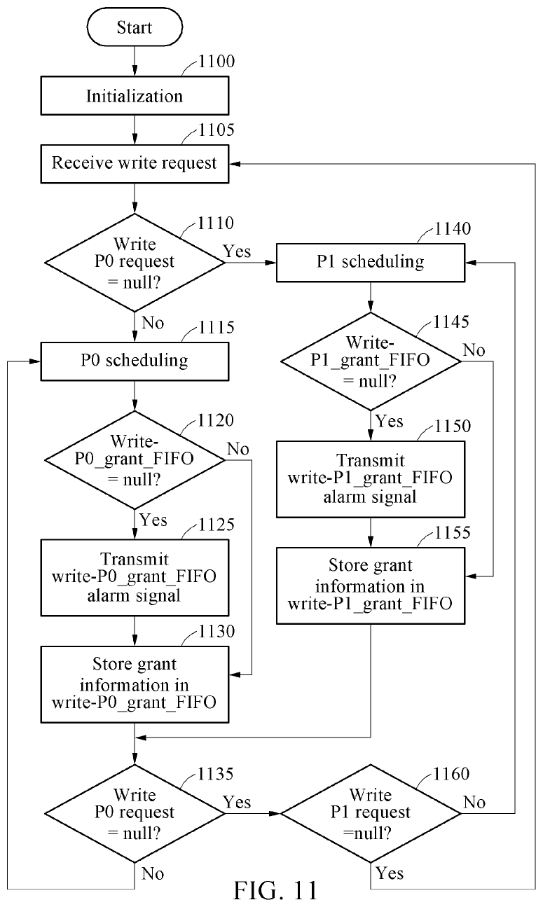

FIGS. 10 and 11 are flowcharts illustrating examples of priority-based read and write scheduling according to an example embodiment.

Two sub-scheduling stages that receive a read or write request may perform scheduling independently based on request information. Although resultant information (or scheduling results) obtained by the scheduling by the two sub-scheduling stages is stored in corresponding grant_FIFO queues, operations of the sub-scheduling stages may be the same. The grant_FIFO queues that store therein the scheduling results may be divided into four based on P0 and P1 for each of reading and writing.

Referring to FIG. 10, after initialization is performed in operation 1000, a read request (or a request for reading) may be received in operation 1005. When a request for P0 is made in operation 1010, scheduling for P0 may be performed in operation 1015. In operation 1020, whether a read-P0_grant_FIFO queue (e.g., read-P0_grant_FIFO as illustrated) is null for which the scheduling is completed may be verified. When the read-P0_grant_FIFO is null, a read-P0_grant_FIFO alarm signal may be transmitted to an access control function of the scheduler 230 in operation 1025, and a scheduling result may be stored in the read-P0_grant_FIFO queue in operation 1030.

In contrast, when the read-P0_grant_FIFO is not null, the scheduling result may be stored in the read-P0_grant_FIFO queue without the transmission of the alarm signal. When the storing of such information is completed, whether a read P0 request remains may be verified in operation 1035. This may be repeated until scheduling for all read P0 requests is completed. When the read P0 request is in a null state, whether a read P1 request is present may be verified in operation 1060. When the P1 request is present, scheduling for the read P1 request may be performed in operation 1040.

When the scheduling for the read P1 request is completed, whether a read-P1_grant_FIFO queue (e.g., read-P1_grant_FIFO as illustrated) is null may be verified in operation 1045. When the read-P1_grant_FIFO queue is verified to be null, a read-P1_grant_FIFO alarm signal may be transmitted in operation 1050, and then a scheduling result may be stored in the read-P1_grant_FIFO queue in operation 1055.

When the read-P1_grant_FIFO queue is not null, the scheduling result may be immediately stored in the read-P1_grant_FIFO queue without the transmission of the alarm signal. When the storing is completed, whether a read P0 request is present may be verified in operation 1035, and scheduling for the read P0 request may be controlled to be performed first. When a read P0 request is in the null state, scheduling for a read P1 request may be performed in operation 1060.

The two sub-scheduling stages receiving a read or write request may perform scheduling independently based on request information. Although scheduling result information of the two sub-scheduling stages may be stored in respectively set grant_FIFO queues, respective scheduling operations may be the same.

A grant_FIFO queue that stores therein a scheduling result may be divided into four based on P0 and P1 for each of reading and writing. When a write sub-scheduling stage receives request information from header processors, whether a P0 request is present or not may be verified. After initialization is performed in operation 1100, a write request may be received in operation 1105. When the P0 request is present in operation 1110, scheduling for P0 may be performed in operation 1115.

Whether a write-P0_grant_FIFO queue (or simply write-P0_grant_FIFO as illustrated) for which the scheduling is completed is null may be verified in operation 1120. When the write-P0_grant_FIFO is null, a write-P0_grant_FIFO alarm signal may be transmitted in operation 1125, and a scheduling result may be stored in the write-P0_grant_FIFO queue in operation 1130. In contrast, when the write-P0_grant_FIFO is not null, the scheduling result may be stored in the write-P0_grant_FIFO queue without the transmission of the alarm signal. When the storing is completed, whether a write P0 request remains may be verified in operation 1135, which may be repeated until the scheduling is completed for all write P0 requests.

When the write P0 request is in a null state, whether a write P1 request is present or not may be verified in operation 1160. When the P1 request is present, scheduling for the write P1 request may be performed in operation 1140. When the scheduling for the write P1 request is completed, whether a write-P1_grant_FIFO queue (or simply write-P1_grant_FIFO as illustrated) is null may be verified in operation 1145. When the write-P1_grant_FIFO queue is null, a write-P1_grant_FIFO alarm signal may be transmitted in operation 1150, and then a scheduling result may be stored in the write-P1_grant_FIFO queue in operation 1155. In contrast, when the write-P1_grant_FIFO queue is not null, the scheduling result may be immediately stored in the write-P1_grant_FIFO queue without the transmission of the alarm signal. When the storing is completed, whether a write P0 request is present may be verified in operation 1135, and scheduling for the write P0 request may be controlled to be performed first. When a write P0 request is in the null state, scheduling for a write P1 request may be performed in operation 1160.

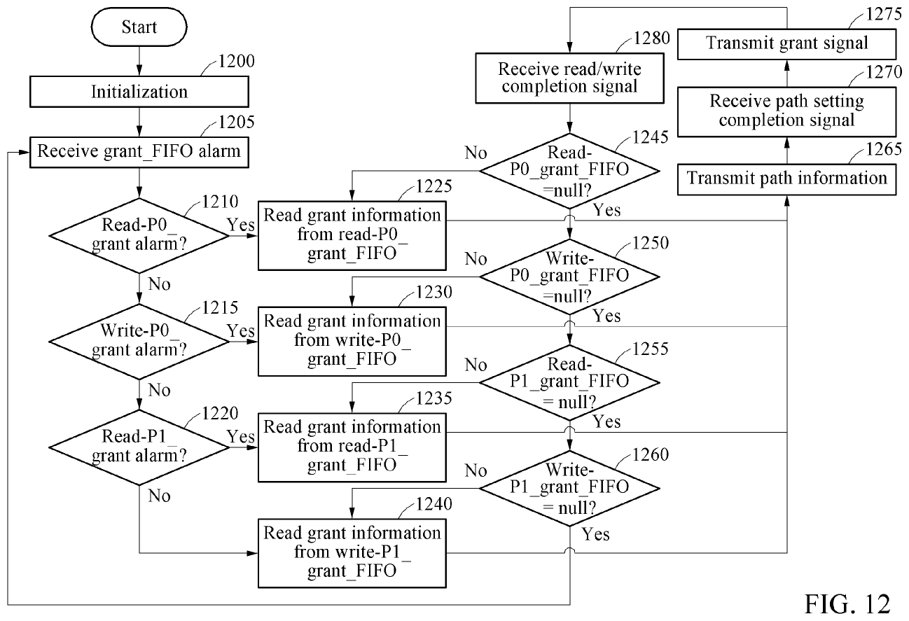

FIG. 12 is a flowchart illustrating an example of an access control function of the scheduler 230 based on a priority according to an example embodiment.

Referring to FIG. 12, when an access control function of the scheduler 230 receives a grant_FIFO alarm signal in operation 1205 after initialization is performed in operation 1200, the alarm signal may be verified in operations 1210, 1215, and 1220, and processing may be performed in sequential order, for example, read-P0, write-P0, read-P1, and write-P1, based on priorities.

For example, when a read-P0_grant_FIFO alarm is 1 in operation 1210, grant information which is a scheduling result may be read from a read-P0_grant_FIFO queue in operation 1225, and path setting information may be transmitted to the R/W connector 250 in operation 1265. When a path setting completion signal is received from the R/W connector 250 in operation 1270, a grant signal may be transmitted to a corresponding header processor 240 in operation 1275.

When a memory read and/or write completion signal is received from the header processor 240 in operation 1280, operations 1245, 1250, 1255, and 1260 may be performed to verify whether queues are null in sequential order, for example, read-P0_grant_FIFO, write-P0_grant_FIFO, read-P1_grant_FIFO, and write-P1_grant_FIFO queues, for next memory access. When the queues are not null, information may be read from a corresponding queue in operations 1225, 1230, 1235, and 1240 to transmit path setting information and a grant signal. When all the grant_FIFO queues are null, the scheduler 230 may wait for a grant_FIFO alarm signal to be received.

A disaggregated memory access control structure and function described above may prevent a collision that may occur when remotely disaggregated computing devices simultaneously access a certain memory access controlling device for memory reading and/or writing, and may thus enable effective utilization of resources.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A memory access controlling device in a parallel processing system, comprising:
an optical transceiver configured to receive an optical signal comprising a memory access frame from an optical circuit switch (OCS);
a memory access controller configured to perform a scheduling operation and a memory access control operation based on the memory access frame, and transmit a memory processing instruction and memory address information to a memory controller; and
the memory controller configured to perform at least one of memory data read or memory data write based on the memory processing instruction and the memory address information,
wherein the memory access controller comprises a plurality of header processors, and is configured to control memory processing instructions to be performed in sequential order based on connection information between each of the header processors and a target memory.

2. The memory access controlling device of claim 1, wherein the memory access controller further comprises:
a scheduler configured to perform scheduling based on memory access request information received from the header processors such that the header processors have a memory access right in sequential order starting from a header processor selected based on a scheduling result obtained by the scheduling, and transmit the scheduling result to a read/write (R/W) connector and the head processors; and
the R/W connector configured to connect the header processors to memory read and write paths based on the scheduling result received from the scheduler.

3. The memory access controlling device of claim 2, wherein the scheduler is configured to perform a plurality of sub-scheduling stages in parallel.

4. The memory access controlling device of claim 3, wherein, in the sub-scheduling stages, the scheduling is performed based on priority information of memory access requests.

5. The memory access controlling device of claim 3, wherein the scheduler is configured to perform, in parallel, scheduling for a memory read request from the header processors and scheduling for a memory write request from the header processors.

6. The memory access controlling device of claim 3, wherein the scheduler is configured to:
store grant information derived as a result of performing the scheduling in a read first in, first out (FIFO) queue and a write FIFO queue, and read and process the grant information from the read FIFO queue and the write FIFO queue in sequential order based on a priority.

7. The memory access controlling device of claim 2, wherein the scheduler is configured to:
transmit path information based on the scheduling result to the R/W connector; and
after setting of a path between a target header processor and the memory controller is completed, transmit a grant signal to the target header processor.

8. The memory access controlling device of claim 4, wherein respective priorities of the memory access requests comprised in the priority information are defined based on at least two of a memory-intensive application, a central processing unit (CPU)-intensive application, memory read, or memory write.

9. A memory access controlling method in a parallel processing system, comprising:
receiving an optical signal comprising a memory access frame from an optical circuit switch (OCS) through an optical transceiver;
performing, by a memory access controller, a scheduling operation and a memory access control operation based on the memory access frame, and transmitting a memory processing instruction and memory address information to a memory controller;
performing, by the memory controller, a memory access operation comprising at least one of memory data read or memory data write based on the memory processing instruction and the memory address information; and
transmitting resultant data obtained by the memory access operation to the OCS through the optical transceiver,
wherein the memory access controller comprises a plurality of header processors, and is configured to control memory processing instructions to be performed in sequential order based on connection information between each of the header processors and a target memory.

10. The memory access controlling method of claim 9, further comprising:
performing, by a scheduler, scheduling based on memory access request information received from the header processors such that the header processors have a memory access right in sequential order starting from a header processor selected based on a scheduling result obtained by the scheduling, and transmitting the scheduling result to a read/write (R/W) connector and the head processors.

11. The memory access controlling method of claim 10, further comprising connecting, by the R/W connector, the header processors to memory read and write paths based on the scheduling result received from the scheduler.

12. The memory access controlling method of claim 10, wherein the scheduler is configured to perform two or more sub-scheduling stages in parallel.

13. The memory access controlling method of claim 12, wherein, in the sub-scheduling stages, the scheduling is performed first for a memory access request with a highest priority based on priority information.

14. The memory access controlling method of claim 12, wherein the scheduler is configured to perform, in parallel, scheduling for a memory read request from the header processors and scheduling for a memory write request from the header processors.

15. The memory access controlling method of claim 12, wherein the scheduler is configured to select an instruction with a highest priority from among results of the scheduling performed in parallel such that the selected instruction is to be processed first.

16. The memory access controlling method of claim 10, wherein the scheduler is configured to transmit path information based on the scheduling result to the R/W connector, and transmit a grant signal to a target header processor after path setting is completed.

17. The memory access controlling method of claim 13, wherein the priority information is defined based on at least two of a memory-intensive application, a central processing unit (CPU)-intensive application, memory read, or memory write.
